(19) United States
(12) Patent Application Publication
(10) Pub. No.: US 2023/0080895 A1
(43) Pub. Date: Mar. 16, 2023

(54) DYNAMIC OPERATION OF A VOICE CONTROLLED DEVICE

(71) Applicant: INTERNATIONAL BUSINESS MACHINES CORPORATION, Armonk, NY (US)

(72) Inventors: DANIEL THOMAS CUNNINGTON, HAMPSHIRE (GB); JOHN JESSE WOOD, HERTFORDSHIRE (GB); GIACOMO GIUSEPPE CHIARELLA, HAMPSHIRE (GB); EUNJIN CHIARELLA, HAMPSHIRE (GB)

(21) Appl. No.: 17/475,493

(22) Filed: Sep. 15, 2021

(51) Int. Cl. G10L 15/22

(52) U.S. Cl. CPC G10L 15/22; G10L 2015/223

(57) ABSTRACT

A voice-controlled device is operated in a location. When a mobile device enters the location, audio outputted by the mobile device is stored. If a voice command is received at the voice-controlled device, the stored audio outputted by the mobile device is accessed. If it is determined that the voice command originated from the mobile device, then the received voice command is ignored.

### BACKGROUND

The present invention relates to a system comprising a voice-controlled device and a mobile device and to a method and computer program product for operating the voice-controlled device and mobile device.

### SUMMARY

According to a first aspect of the present invention, there is provided a computer implemented method comprising operating a voice-controlled device in a location, determining that a mobile device has entered the location, storing audio outputted by the mobile device, receiving a voice command at the voice-controlled device, accessing the stored audio outputted by the mobile device, determining that the voice command originated from the mobile device, and ignoring the received voice command.

According to a second aspect of the present invention, there is provided a system comprising a voice-controlled device arranged to determine that a mobile device has entered the location; receive a voice command; access stored audio outputted by the mobile device; determine that the voice command originated from the mobile device; and ignore the received voice command, the system further comprising a mobile device arranged to output audio and store the outputted audio.

According to a third aspect of the present invention, there is provided a computer program product for controlling a voice-controlled device comprising a processor, the computer program product comprising a computer readable storage medium having program instructions embodied therewith, the program instructions executable by the processor to cause the voice-controlled device to operate a voice-controlled device in a location, determine that a mobile device has entered the location, store audio outputted by the mobile device, receive a voice command at the voice-controlled device, access the stored audio outputted by the mobile device, determine that the voice command originated from the mobile device, and ignore the received voice command.

### BRIEF DESCRIPTION OF THE DRAWINGS

Some embodiments of the present invention will now be described, by way of example only, with reference to the following drawings:

FIG. 1 is a schematic diagram of a location including a voice-controlled device, according to at least one embodiment of the present disclosure.

FIG. 2A is a flow diagram of a method for voice command filtering, according to at least one embodiment of the present disclosure.

FIG. 2B is a flow diagram of another method for voice command filtering, according to at least one embodiment of the present disclosure.

FIG. 3 is a block diagram of a computing environment, according to at least one embodiment of the present disclosure.

FIG. 4 is a high-level block diagram of a computer system, according to at least one embodiment of the present disclosure.

FIG. 5 is a schematic diagram of a location including a voice-control device and a mobile device, according to at least one embodiment of the present disclosure.

FIG. 6 is a flow diagram of a method of operating the voice-control device and mobile device of FIG. 5, according to at least one embodiment of the present disclosure.

### DETAILED DESCRIPTION

Aspects of the present disclosure relate generally to the field of voice-controlled devices, and in particular to voice command filtering. While the present disclosure is not necessarily limited to such applications, various aspects of the disclosure may be appreciated through a discussion of various examples using this context. Voice controlled devices (VCD, also referred to as voice command devices) are controlled by human voice commands. Devices are controlled by human voice commands to remove the need to operate a device using hand controls such as keyboards, buttons, dials, switches, user interfaces, etc. This enables a user to operate such devices whilst their hands are occupied with other tasks or if they are not close enough to the device to touch the device.

Complications arise when a VCD is triggered by a voice command from a television, radio, computer, or other non-human device that emits a voice in the vicinity of the VCD. For example, a VCD in the form of a smart speaker incorporating a voice-controlled intelligent personal assistant may be provided in a living room. The smart speaker may erroneously respond to audio from another device such as a television, believing the audio to be a voice command from a user. Sometimes this may be a benign command that the smart speaker does not understand; however, occasionally the audio is a valid command or trigger word that may result in an action by the VCD.

A voice-controlled device (VCD) can be provided with additional functionality to identify valid voice commands by ignoring voice commands from blocked directions from which background voice noise is known to originate, when the VCD is positioned in a given location. The VCD identifies directions where background noise or strings are usually heard. Strings may be background audio samples that may include spoken words or text. The identified direction may be tagged as a potential location of a sound emitting device that should be ignored by the VCD. The functionality may be refined by ignoring voice commands from a blocked direction unless they are from a recognized voice, for example, a registered voice of the VCD identified by the voice tone and pattern.

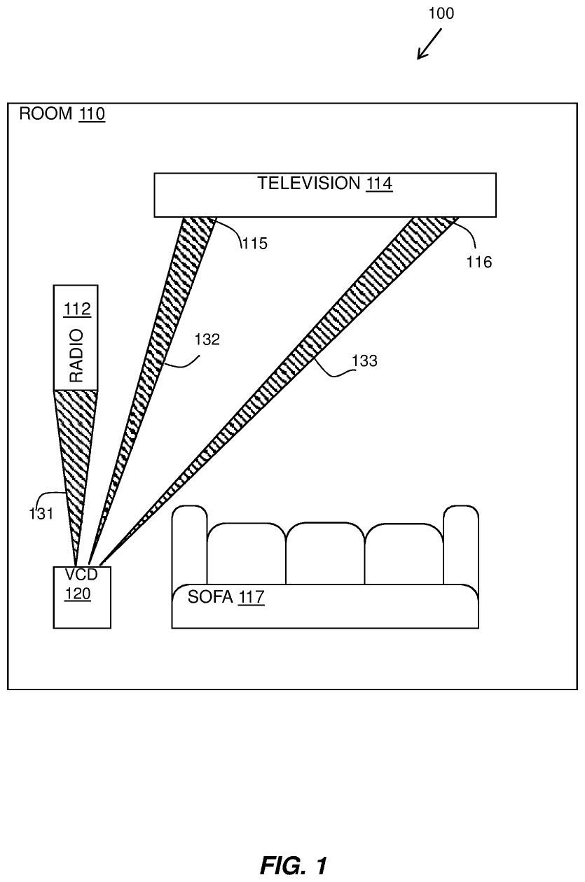

Referring to FIG. 1, a location 100 comprises a room 110 in which a voice-control device (VCD) 120 may be regularly positioned. For example, the VCD 120 may be in the form of a smart speaker including a voice-controlled intelligent personal assistant that is located on a table next to a sofa 117 in the room 110. The room 110 may include a television 114 from which audio may be emitted from two speakers 115, 116 associated with the television 114. The room 110 may also include a radio 112 with a speaker. The VCD 120 may, at various times, receive audio inputs from the two television speakers 115, 116 and the radio 112. These audio inputs may include voices that include command words that unintentionally trigger the VCD 120 or provide input to the VCD 120.

The VCD 120 is able to store details of directions (such as relative angles) of audio inputs that should be ignored for a given location of the VCD 120. Over time, the VCD 120 may learn to identify sources of background noise in a room 110 by the direction of their audio input to the VCD 120. In this example, the radio 112 is located at approximately 0 degrees in relation to the VCD 120 and a hashed triangle 131 illustrates how the audio output of the radio 112 may be received at the VCD 120. The two speakers 115, 116 of the television 114 may be detected as being located in directions of approximately 15-20 degrees and 40-45 degrees respectively and hashed triangles 132, 133 illustrates how the audio output of the speakers 115, 116 may be received at the VCD 120. Over time, these directions may be learned by the VCD 120 as blocked directions from which audio commands are to be ignored.

In another example, a VCD 120 may be a fixed appliance such as a washing machine and a blocked direction may be learned for a source of audio input such as a radio in the same room as the washing machine. If the VCD 120 receives a command from these blocked directions, the VCD 120 may ignore the command unless the VCD 120 is configured to accept commands from these directions from a known registered user's voice. The VCD 120 is configured to enable the VCD 120, which is often positioned in a given location 100, to ignore unwanted sources of commands for that location.

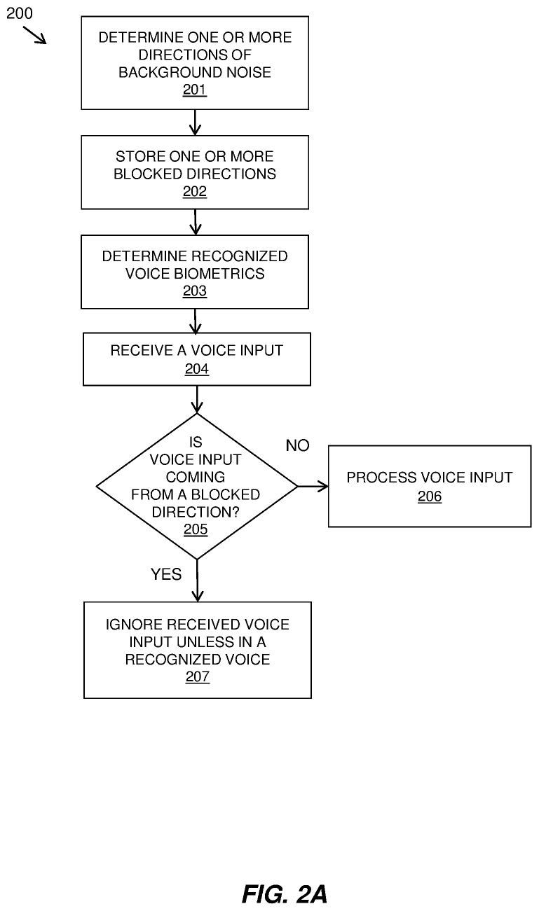

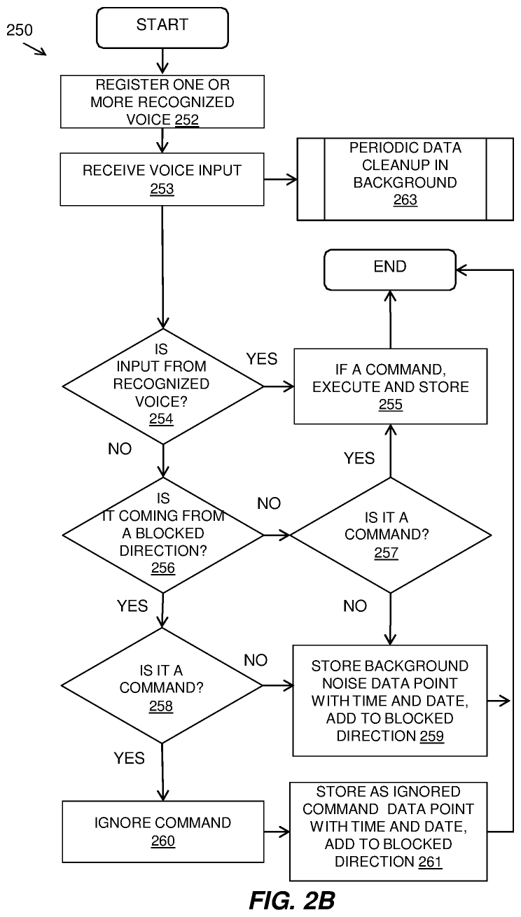

FIG. 2a is a flow diagram illustrating a process 200 for filtering audio inputs received by the voice-control device 120. The process 200 begins by determining one or more directions of background voice noise. This is illustrated at step 201. The VCD 120 may learn the directions for the location by receiving background audio inputs from these directions, and analyzing the relative direction in which the audio inputs are received from, which may include both voice and non-voice background noises. In some embodiments, determining the one or more directions of background noise is completed by triangulation (for example by measuring the audio input at two or more known locations, which can be microphones mounted in the VCD 120, in space and determining the direction and/or location of the audio input by measuring the angles from the known points). Triangulation can be completed by including two or more microphones in the VCD 120 and cross referencing the audio data received at the two or more microphones. In some embodiments, the one or more blocked directions can be determined by time difference of arrival (TDOA). This method can similarly utilize two or more microphones. The data received at the two or more microphones can be analyzed to determine a location of the received audio input based on the difference of arrival of the audio input. In some embodiments, the one or more blocked directions can be determined by associating sensors (for example by optical sensors, GPS sensors, RFID tags, etc.) with speakers in the room (for example the speakers 115, and 116 of FIG. 1) and using the sensors to determine the blocked direction. For example, optical sensors can be associated with the VCD 120 and one or more speakers in the room. The blocked directions can then be determined by the optical sensor associated with the VCD 120. Alternatively, directions of background voice noise may be configured by a user.

The one or more blocked directions are then stored. This is illustrated at step 202. The one or more blocked directions can be stored in any suitable memory (for example flash memory, RAM, hard disk memory, etc.). In some embodiments, the one or more blocked directions are stored on local memory on the VCD 120. In some embodiments, the one or more blocked directions can be transmitted over a network and stored on another machine.

In addition, the VCD 120 determines recognized voice biometrics. This is illustrated at step 203. Determining recognized voice biometrics can be completed by, for example, applying voice recognition for one or more registered voices. The voice recognition may utilize characteristics of the voice such as pitch and tone. The recognized voice biometrics can be stored on the VCD 120 to determine whether incoming voices are registered with the VCD 120. This can be accomplished by comparing the incoming voices to the recognized voice biometrics to determine whether the incoming voice is a recognized voice.

A voice input is then received. This is illustrated at step 204. The voice input can be received by a human or non-human entity. Accordingly, the term “voice input” does not necessarily have to be a voice, but can rather include background noise, such as a running laundry machine or music from a speaker.

A determination is then made whether the voice input is coming from a blocked direction. This is illustrated at step 205. Determining whether the voice input is coming from a blocked direction can be completed by comparing the stored blocked directions to the direction the voice input was received from to determine if the received voice input is associated with a stored blocked direction. If the voice input is coming from a direction which differs from the stored blocked directions, then a determination can be made that the voice input is not coming from a blocked direction.

If a determination is made that the voice input is not coming from a blocked direction, then the voice input is processed. This is illustrated at step 206. In some embodiments, processing includes identifying a command and executing the received command. In some embodiments, processing can include comparing the received voice input to stored command data (for example data that specifies command words and command initiation protocols) to determine whether the received voice input corresponds to or matches a command of the stored command data. For example, if the voice input includes the phrase “Power Off”, and “Power Off” is specified as a command initiation phrase in the stored command data, then a determination can be made that the voice input is a command and the command can be executed, with the power being turned off.

If a determination is made that the voice input is received from a blocked direction, it can be ignored unless it is associated with a recognized voice. This is illustrated at step 207. To determine whether the voice in the blocked direction is a recognized voice, tonal/pitch analysis of the received audio voice can be completed in response to a determination that the voice input is received from a blocked direction. If the tonal/pitch analysis indicates that the voice input is a voice associated with a recognized user, then the voice input can be processed, for example as in step 206.

Referring to FIG. 2B, shown is a flow diagram of an example process 250 for filtering audio data received by a voice-controlled device such as the VCD 120. The process 250 starts where one or more recognized voices are registered on the VCD. This is illustrated at step 252. For example, the VCD may include functionality to register a primary user of the VCD to ensure the voice biometrics of the voice are easily recognized. The voice registration can be completed by analyzing various voice inputs from a primary user. The analyzed voice inputs can then be used to distinguish a tone and pitch for the primary user. Alternatively, regularly received voices may be automatically learned and registered by recording pitch and tonal data received during the use of the device. Having voice recognition functionality may not exclude commands or inputs from other non-registered voices from being accepted by the VCD. In some embodiments, no voices may be registered, and the method may block directions for all voice inputs.

A voice input is then received. This is illustrated at step 253. In some embodiments, non-voice inputs are automatically filtered, which may be an inherent functionality to a VCD. In some embodiments, voice inputs may include background noise voices or strings, which include non-human voice inputs. A determination is then made whether the voice input is associated with a recognized voice. This is illustrated at step 254. Determining whether the voice input is associated with a recognized voice can be completed by analyzing the voice biometrics of the received voice input, for example by completing a tone and pitch analysis of the received voice input and comparing the analyzed voice input data to the registered voice biometrics.

If the voice input is associated with a recognized voice, and the voice input is a command, the command is executed. This is illustrated at step 255. This enables the VCD to respond to voice inputs from registered users regardless of the direction from which the voice input is received including if it is received from a blocked direction. The method may store a data point of a valid command for learning purposes including, optionally storing the time at which and direction from which the voice command was received. This may be used, for example, to learn common directions of valid commands, such as from a favorite position in relation to the VCD that may be boosted for more sensitive command recognition.

If the voice input is not from a recognized voice, a determination can be made whether the voice input is originating from a blocked direction. This is illustrated at step 256. Determining the direction of a voice input may include measuring the angle of the incoming voice input. VCDs may have known functionality for evaluating a direction of incoming sound. For example, multiple microphones may be positioned on the device and the detection of the sound across the multiple microphones may enable the position to be determined, for example by using triangulation or time of arrival difference. A blocked direction may be stored as a range of angles of incidence of incoming sound to the receiver. In the case of multiple microphones, the blocked direction may be for voice inputs received predominantly or more strongly at one or more of the multiple microphones. The direction of the incoming sound may be determined in a three-dimensional arrangement with input directions determined from above or below as well as in a lateral direction around the VCD.

If the voice input is not from a blocked direction, a determination is made whether the voice input is a command. This is illustrated at step 257. If it is a command, then the command may be executed at step 255. This enables a command to be executed from a non-registered voice, i.e., from a new or guest user and does not restrict the user of the VCD to registered users. The method may store the command as a command data point, optionally, including the direction from which the command was received. This may be analyzed for further voice registration, to determine if the command is overridden by a further user input, etc. The method may then end and await a further voice input.

If a determination is made that the voice input is not from a blocked direction and is not a command, a determination is made that the audio input is a source of background noise. The background noise data is then time stamped with a time, date, and the direction, such as the angle of incidence, the background noise was received from. The direction can then be added as a blocked direction such that if voice inputs are repeatedly received from this direction they can be blocked. This is illustrated at step 259. A threshold can be implemented to determine when a voice input received from a non-blocked direction that does not specify a command can be determined to be background noise.

For example, a plurality of voice inputs can be received from a particular direction. Further, each of the plurality of voice inputs is received at a distinct time. The plurality of received voice inputs can be compared to stored command data to determine whether each (for example individually, not collectively) of the plurality of received voices corresponds to the stored command data. The number of voice inputs of the plurality of voice inputs that do not correspond to the stored command data can be determined. The number of voice inputs that do not correspond to the stored command data can be compared to a non-command voice input threshold (for example a threshold that specifies a number of non-command voice inputs that can be received for a given direction before storing the given direction with the one or more blocked directions). In response to the number of voice inputs that do not correspond to the stored command data exceeding the non-command voice input threshold, the particular direction can be stored with the one or more blocked directions. In some embodiments, the background noise threshold includes sound characteristic information, such as frequency and amplitude.

If a determination is made that the voice input is a command, the command may be ignored. This is illustrated at step 260. The voice input may then be stored as an ignored command data point with a timestamp of a time and date together with the received direction of the voice input. This is illustrated at step 261. This data may be used for analysis of blocked directions. Further, this data may be used to analyze whether a device is still located at a blocked direction, by referencing the stored time and date of the background noise data points. A threshold number of non-identified voice commands may be stored from a given direction before adding the direction to the blocked directions.

The analysis of stored data points of valid voice commands, background noise inputs, and ignored or invalid commands recorded with the incoming directions may be carried out to learn blocked directions, and, optionally, common directions for valid commands. A periodic data cleanup (for example formatting and filtering) may be carried out at step 263 as a background process of the stored data points.

Data points may be stored to allow the method and system to identify more precisely directions in which noise should be ignored. Noise which is not from a recognized voice coming from a known blocked direction can be ignored regardless of whether it is a command or not. Storing data points of different types of noise allows for further analysis of background noise and thus gives finer discrimination on which directions to block. For example, an oven beeping may be received by a VCD from the direction of the oven. Over time, the background noise data points may be analyzed to identify that the background noise data point in this direction has never included a command, or the background noise data points from a given direction are very similar in terms of the audio content. In this case, commands may be allowed from this direction.

The VCD may include a user input mechanism to override blocked direction inputs or to override execution of a command. The method may also learn from such override inputs from the user to improve on the performance.

This method assumes that the VCD stays in the same location in the same room, which is often the case. If the VCD is moved to a new location, it may relearn its environment to identify block directions for non-human sources in relation to the VCD at the new location. The method may store blocked directions in relation to a given location of the VCD so that the VCD may be returned to a previous location and reconfigure the blocked directions without relearning its environment.

In some embodiments, the method may allow configuration of known directions to be blocked. This may remove the need or be in addition to the learning of blocked directions over time and may enable a user to pre-set blocked directions from their knowledge of the directions from which interfering audio may be received.

The user may position the VCD at a location and the VCD may allow input to configure the blocked locations. This may be via a graphical user interface or via a remote programming service, for example. In one embodiment, the configuration of blocked directions may be carried out using voice commands by a user standing at an angle to be blocked, such as in front of a television, and commanding that direction to be blocked. In another embodiment, a pre-configuration of a room may be loaded and this may be stored for use if the VCD is moved.

Using the example shown in FIG. 1, the VCD 120 may start picking up commands from the television 114 and may store the direction of these incoming commands. The method may then filter out commands and background noise that are always issued from the same direction. Commands from that direction that are not in line with the voices that usually give commands from other directions will be ignored.

An advantage of the described method is that, unlike devices that block all commands that are not from a known user, the VCD may include an additional level of verification in the form of direction. When a new user arrives in the proximity of the VCD and issues a command, the VCD may still execute the command because it is coming from a direction which is not blocked due to association with static audio emitting objects.

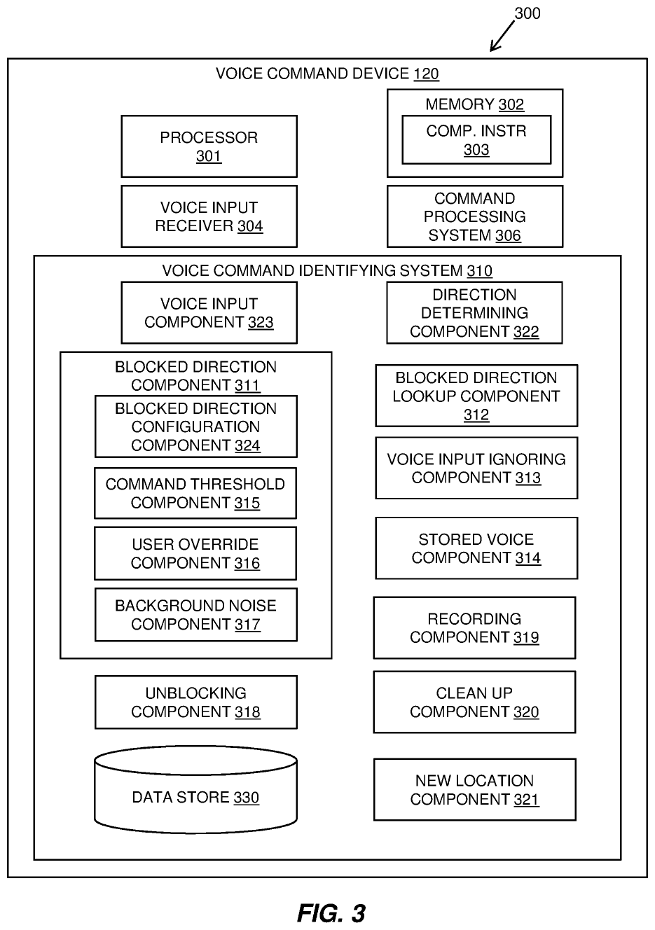

FIG. 3 is a block diagram illustrating a computing environment 300 in which a VCD can be implemented. The VCD 120 may be a dedicated device or part of a multi-purpose computing device including at least one processor 301, a hardware module, or a circuit for executing the functions of the described components. Multiple processors running parallel processing threads may be provided enabling parallel processing of some or all of the functions of the components. Memory 302 may be configured to provide computer instructions 303 to the at least one processor 301 to carry out the functionality of the components. The VCD 120 may include a voice input receiver 304 that is dependent on the type of device and known voice processing. In one embodiment, the voice input receiver 304 may be in the form of multiple microphones provided in an array to receive voice inputs from different directions relative to the VCD 120.

The VCD 120 may include a command processing system 306. The command processing system 306 can include computer instructions to process voice commands received from the voice input receiver 304. In addition, a voice command identifying system 310 is provided. The voice command identifying system 310 can include computer instructions to identify voice commands received at the voice input receiver 304. The VCD software including voice command recognition processing may be provided locally to the VCD 120 or computing device or may be provided as a remote service over a network, for example as a cloud-based service. The voice command identifying system 310 may be provided as a downloadable update at the VCD software or may be provided as an individual add-on remote service over a network, for example as a cloud-based service.

The voice command identifying system 310 may include a voice input component 323 for receiving a voice input and a direction determining component 322 for determining a direction the voice input is being received from in relation to the position of the VCD 120. The voice input component 323 may receive inputs from the voice input receiver 304 (which can include indicated directions) and from the command processing system 306 (including voice inputs filtered from non-voice inputs). The voice command identifying system 310 may include a blocked direction component 311 for learning blocked directions for a given location of the VCD 120 and storing blocked directions in a data store 330.

The voice command identifying system 310 may include a blocked direction lookup component 312 for determining if a new voice input is being received from a stored blocked direction relative to the VCD 120 and a voice input ignoring component 313 for ignoring the received voice input if it is from a blocked direction unless the received voice input is in a recognized command voice as determined by a stored voice component 314. The stored voice component 314 may compare a voice input to stored voice biometrics of registered or recognized command voices to determine if the voice input is in a recognized command voice.

The blocked direction component 311 may carry out analysis and learning from stored data points of received commands and received background noise and may include a command threshold component 315 for blocking a direction when a threshold number of invalid or non-identified commands are received from that direction. The blocked direction component 311 may include a user override component 316 for receiving user instruction to disregard the voice input and add the direction of the voice input to the blocked directions. The blocked direction component 311 may include a background noise component 317 for learning a direction of background noises and blocking background noise from the direction. In addition to or as an alternative to the blocked direction component 311, the voice command identifying system 310 may include a blocked direction configuration component 324 for user configuration of blocked directions at the VCD 120 for a given location.

The voice command identifying system 310 may include an unblocking component 318 for receiving user instruction that a voice input is valid and removing a direction of voice inputs from the blocked directions. The voice command identifying system 310 may include a recording component 319 for recording received voice inputs as stored data points with a timestamp and received direction at a data store 330 for analysis to learn blocked directions. A clean up component 320 may carry out a background clean-up of the recorded received voice inputs in the data store 330. The voice command identifying system 310 may include a new location component 321 for determining that a VCD 120 has a new location, resetting blocked directions, and learning blocked directions for the new location.

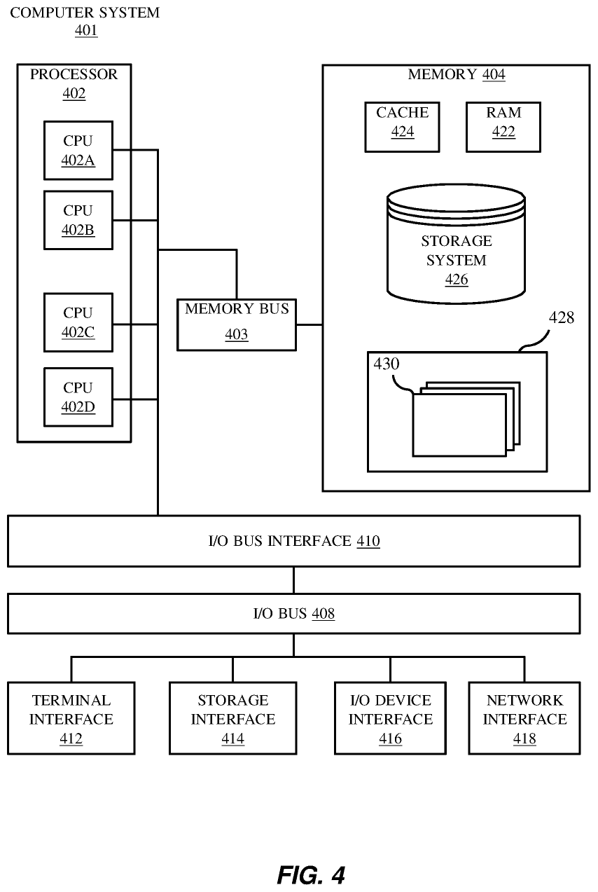

Referring now to FIG. 4, which shows a high-level block diagram of an example computer system 401 (for example the VCD 120 of FIGS. 1 and 3) that may be used in implementing one or more of the methods, tools, and modules, and any related functions, described herein, using one or more processor circuits or computer processors of the computer, in accordance with embodiments of the present disclosure. In some embodiments, the major components of the computer system 401 may comprise one or more CPUs 402, a memory subsystem 404, a terminal interface 412, a storage interface 414, an I/O (Input/Output) device interface 416, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random-access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard-drive.” Although not shown, a magnetic disk drive for reading from and writing to a removable, non-volatile magnetic disk such as a “USB thumb drive” or “floppy disk”, or an optical disk drive for reading from or writing to a removable, non-volatile optical disc such as a CD-ROM, DVD-ROM or other optical media can be provided. In addition, memory 404 can include flash memory, such as a flash memory stick drive or a flash drive. Memory devices can be connected to a memory bus 403 by one or more data media interfaces. The memory 404 may include at least one program product having a set (at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

In some embodiments, the program modules 430 of the computer system 401 include a voice command filtering module. The voice command filtering module can be configured to determine one or more directions of background noise for a location of a voice command device. Further, the voice command filtering module can be configured to store, in response to determining the one or more directions of background noise, the one or more directions of background noise as one or more blocked directions. The voice command filtering module can be configured to receive a voice input at the voice command device at the location, and determine a direction the voice input is received from. The voice command filtering module can further be configured to compare the direction the voice input is received from to the one or more block directions, and ignore, in response to the direction the voice input is being received from corresponding to a direction of the one or more blocked directions, the received voice input unless the voice input is in a recognized voice.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smart phone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

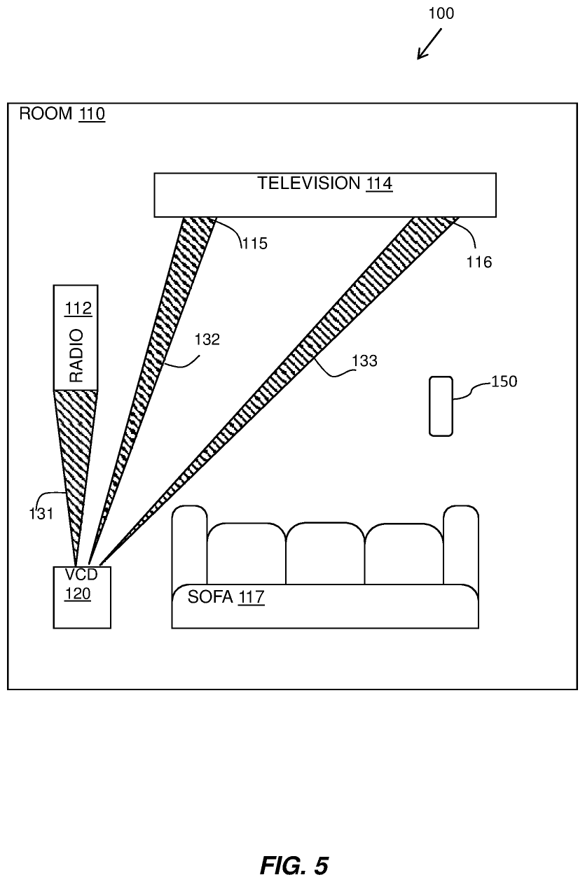

FIG. 5 shows a view similar to that shown in FIG. 1, which is of the location 100. In addition to the components shown in FIG. 1, a mobile device 150 has entered the location 100. The mobile device 150 could be a smartphone, which has local (such as Bluetooth and Wi-Fi) and wide area (such as 4G) wireless capabilities as well as processing and storage capabilities. The mobile device 150 also has an audio output device (one or more speakers) and an audio input device (one or more microphones). The mobile device 150 may also have voice control/command software functionality provided thereon, which allows the mobile device 150 to be controlled by a user's voice.

The dynamic introduction of the mobile device 150 into the location 100 has the potential to confuse the operation of the existing static VCD 120, since the mobile device 150 can be considered as an additional source of (background) audio output that could lead to commands being inadvertently received and acted on by the VCD 120 from the mobile device 150. Equally audio outputs from the existing background sources of audio (the radio 112 and the television 114) could confuse the operation of the voice control functionality present on the mobile device 150 (if the mobile device 150 has such a functionality). The introduction of new devices such as the mobile device 150 can be handled by the VCD 120 to minimise the likelihood of disruption in the voice controlled operation of the VCD 120 and the operation of the mobile device 150.

This VCD 120 is configured to enable the mobile device 150 to announce itself as a background noise source to the static VCD 120 upon entering the environment of the static VCD 120. This secures the static VCD 120 against unwanted commands originating from the mobile device 150. Each time the mobile device 150 emits a sound, it informs the VCD 120 that the sound originated from the mobile device 150, so that the VCD 120 can block unwanted commands. This provides the added benefit that the VCD 120 will not add the mobile device 150 to its spatial map of static background noise sources.

When the mobile device 150 first enters a new environment where the VCD 120 is present, the mobile device 150 communicates with the VCD 120 located in the environment through Bluetooth, WiFi, an inaudible command or another localised communication technology to setup a pairing. This handshake pairing involves the generation of a token on the mobile device 150. The mobile device 150 will send the token to the VCD 120 that the VCD 120 will store.

Each time the mobile device 150 emits a sound, the mobile device 150 sends a message to the VCD 120 indicating sound is being emitted. Also, the token is sent to enable the VCD 120 to identify which device 150 is emitting audio. This will be sent either through an inaudible command or an alternative secondary means of communication (for example WiFi or Bluetooth). Alternatively, if a user is streaming a video or audio clip, the mobile device 150 can inform the VCD 120 of the length of the streamed content, to avoid repeatedly sending a message.

If the VCD 120 is triggered whilst a token and message is being received, for example if the VCD 120 is activated using its trigger phrase “Alexa”, “Ok Google”, etc. the VCD 120 queries the mobile device 150 according to the device token for its recent audio sample. The VCD 120 can then analyse the audio from the mobile device 150 for any trigger words. The VCD 120 can then decide whether or not to block a command. If there is a command found in the audio sample from the mobile device 150, the VCD 120 can block the command as this did not originate from a human. Otherwise, the VCD 120 can execute the command. This check is to ensure that legitimate, human commands can be executed whilst background noise from a mobile device 150 is playing.

As the mobile device 150 is a temporary source of background noise and can also move in the environment, the use of a token instructs the VCD 120 not to add the mobile device to its list of known background noise sources with a fixed direction attached. Therefore, the VCD 120 will not update its spatial model with an additional background noise source.

Periodically, the VCD 120 will query the mobile device 150 using a localised communication technology to check that the mobile device 150 remains present in the environment. If the mobile device 150 does not respond to the VCD query within a specified time limit, the token associated with this mobile device 150 will be removed from the VCD's store and can be assumed the mobile device 150 has left the environment.

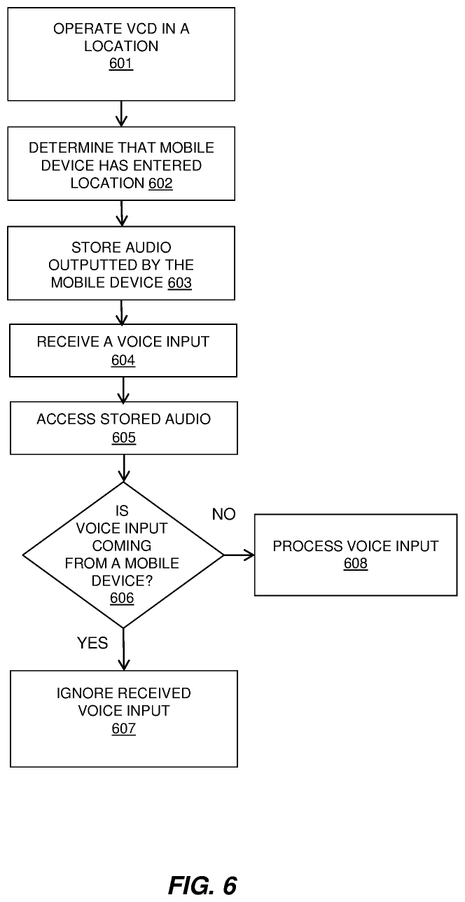

FIG. 6 is a flowchart showing the operation of the VCD 120 when the mobile device 150 enters the environment 110. The first step of the method is step 601, which comprises operating a voice-controlled device 120 in a location 100 and the second step of the method is step 602, which comprises determining that a mobile device 150 has entered the location 100. The discovery of a new mobile device 150 in the location 100 can be triggered directly by the mobile device 150 itself informing the VCD 120 that a new device is present or the VCD 120 can continually ping using a known local area wireless technology such as Bluetooth to discover new devices. Alternatively, a user can also trigger the process, either from the new mobile device 150 or from the VCD 120, by connecting the devices over Bluetooth (or the like) or initiating a dedicated new device connection process on the VCD 120.

The next step of the method is step 603, which comprises storing audio outputted by the mobile device 150. This could be stored locally on the mobile device 150 or by the VCD 120 or remotely in some cloud-based storage system. The outputted audio could be stored in more than one place if required. For example, if a user is watching a video on their mobile device 150, as this is being played, the audio that accompanies the video is being stored. This can be via a dedicated buffer that stores the last x minutes of audio that is being outputted by the mobile device 150, for example the last 2 minutes or the last 5 minutes of audio.

The next step of the method is step 604, which comprises receiving a voice command at the mobile device 150 and this is followed by step 605, which comprises accessing the stored audio. The VCD 120 accesses the stored audio, for example by querying the mobile device 150 for at least a portion of the stored audio (such as the last 30 seconds of audio outputted) and this can be provided by the mobile device 150 to the VCD 120. At step 606, which comprises determining if the voice command originated from the mobile device 150, the VCD 120 will search through the stored audio for the voice command and step 607 comprises ignoring the voice command. If the voice command cannot be found in the stored audio, then the method terminates at step 608 instead, which comprises processing the voice input. This step preferably comprises analysing the accessed stored audio outputted by the mobile device 150 and locating the voice command within the analysed audio.

Preferably the method also includes the step of generating a token for the mobile device 150 and transmitting the generated token from the mobile device 150 to the voice-controlled device 120, when the mobile device 150 is outputting audio. A token-based system can be used where a handshake is used to generate a token when a new mobile device 150 enters the environment where the VCD 120 is located. Each time the mobile device 150 emits a sound, a message and the token are sent, preferably over a secondary means of communication such as a local Wi-Fi network. If the VCD 120 is triggered whilst a message is being received, the VCD 120 queries the mobile device 150 for a recent audio sample and then decides whether or not to execute the received command.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method comprising:
operating a voice-controlled device in a location;
determining that a mobile device has entered the location;
storing audio outputted by the mobile device;
receiving a voice command at the voice-controlled device;
accessing the stored audio outputted by the mobile device;
determining from the stored audio that the voice command originated from the mobile device; and
ignoring the received voice command.

2. The method according to claim 1, and further comprising generating a token for the mobile device and transmitting the generated token from the mobile device to the voice-controlled device, when the mobile device is outputting audio.

3. The method according to claim 1, and further comprising, following receipt of a voice command at the voice-controlled device, transmitting a query from the voice-controlled device to the mobile device requesting at least a portion of the stored audio outputted by the mobile device.

4. The method according to claim 1, wherein the step of determining that the voice command originated from the mobile device comprises analysing the accessed stored audio outputted by the mobile device and locating the voice command within the analysed audio.

5. The method according to claim 1, and further comprising periodically querying the mobile device to determine whether the mobile device is still present in the location.

6. A system comprising:
a voice-controlled device in a location, arranged to:
determine that a mobile device has entered the location;
receive a voice command;
access stored audio outputted by the mobile device;
determine that the voice command originated from the mobile device; and
ignore the received voice command, the system further comprising:
a mobile device arranged to output audio and store the outputted audio.

7. The system according to claim 6, wherein the mobile device is further arranged to generate a token for the mobile device and transmit the generated token from the mobile device to the voice-controlled device, when the mobile device is outputting audio.

8. The system according to claim 6, wherein the voice-controlled device is further arranged, following receipt of a voice command, to transmit a query to the mobile device requesting at least a portion of the stored audio outputted by the mobile device.

9. The system according to claim 6, wherein the voice-controlled device is arranged, when determining that the voice command originated from the mobile device, to analyse the accessed stored audio outputted by the mobile device and locate the voice command within the analysed audio.

10. The system according to claim 6, wherein the voice-controlled device is further arranged to periodically query the mobile device to determine whether the mobile device is still present in the location.

11. A computer program product for controlling a voice-controlled device comprising a processor, the computer program product comprising a computer readable storage medium having program instructions embodied therewith, the program instructions executable by the processor to cause the voice-controlled device to:
operate a voice-controlled device in a location;
determine that a mobile device has entered the location;
store audio outputted by the mobile device;
receive a voice command at the voice-controlled device;
access the stored audio outputted by the mobile device;
determine that the voice command originated from the mobile device, and
ignore the received voice command.

12. The computer program product according to claim 11 and further comprising instructions for generating a token for the mobile device and receiving the generated token at the voice-controlled device from the mobile device, when the mobile device is outputting audio.

13. The computer program product according to claim 11, and further comprising instructions for, following receipt of a voice command at the voice-controlled device, transmitting a query from the voice-controlled device to the mobile device requesting at least a portion of the stored audio outputted by the mobile device.

14. The computer program product according to claim 11, wherein the instructions for determining that the voice command originated from the mobile device comprise instructions for analysing the accessed stored audio outputted by the mobile device and locating the voice command within the analysed audio.

15. The computer program product according to claim 11, and further comprising instructions for periodically querying the mobile device to determine whether the mobile device is still present in the location.
